(19) United States
(12) Patent Application Publication
(10) Pub. No.: US 2025/0075810 A1
(43) Pub. Date: Mar. 6, 2025

(54) VALVE

(71) Applicant: TI Automotive Technology Center GmbH, Rastatt (DE)

(72) Inventors: Artem TUZIN, Stutensee (DE); Matthias Bernhard Olbrich, Rastatt (DE)

(21) Appl. No.: 18/811,354

(22) Filed: Aug. 21, 2024

(30) Foreign Application Priority Data
Aug. 29, 2023 (EP) 23194016.4

(51) Int. Cl. F16K 11/085

(52) U.S. Cl. CPC F16K 11/0853

(57) ABSTRACT

A valve includes a valve housing with a valve chamber, wherein the valve chamber has a chamber wall into which at least one fluid channel opens, wherein a valve core is mounted in the valve chamber, wherein the valve core is provided with a channel structure which interacts with the fluid channel, and wherein a seal is allocated to the fluid channel. The seal has a sleeve-shaped retaining body, wherein the retaining body is arranged in the fluid channel, and wherein a sealing body is arranged on one end face of the retaining body. The sealing body has a curved sealing contour which points in the direction of the valve core.

### RELATED APPLICATIONS

The present disclosure claims priority to and the benefit of European Application 23194016.4, filed on Aug. 29, 2023, the entire contents of each of which are incorporated herein by reference.

### FIELD

The present disclosure relates to a valve comprising a valve housing with a valve chamber, wherein the valve chamber has a chamber wall into which at least one fluid channel opens, wherein a valve core is mounted in the valve chamber, wherein the valve core is provided with a channel structure which interacts with the fluid channel, and wherein a seal is allocated to the fluid channel.

### BACKGROUND

A valve is known from WO 2017/095994 A1. The valve described there is formed as a rotary valve and is used in cooling circuits to control the coolant flow. A cooling fluid can flow in and out of the valve through the fluid openings that open into the valve housing. The channel structure which is introduced into the valve core controls the coolant flow, wherein, depending on the embodiment and number of fluid channels, different cooling circuits can be controlled, the volume flow of the coolant can be regulated and/or the flow direction of the coolant can be adjusted.

With a rotary valve, the coolant flow is adjusted by rotating the valve core, wherein the corresponding actuator for rotating the valve core is formed in a simple manner and is easy to control. Accordingly, rotary valves and the associated actuators are inexpensive to manufacture and require little installation space.

Accordingly, rotary valves are particularly advantageous for the use in temperature control circuits in the field of electromobility. The components of electric vehicles whose temperature needs to be controlled are, in particular, electrical energy storage devices, the power electronics or plug connections of fast-charging devices. The temperature control medium flowing through the temperature control circuit can be heated in a heating device or cooled in a cooling device, depending on the requirements. The temperature control medium is controlled via one or more rotary valves.

To prevent internal leakage, a sealing body is arranged in the area of the transition between the fluid channel and the valve core. We have discovered that a problem here is that, depending on the embodiment, the sealing body can cause high frictional forces, which has a negative effect on wear and the required actuating force of the actuator.

### BRIEF SUMMARY

The present disclosure provides a valve that can be manufactured at low cost and has a long service life.

One valve according to the disclosure comprises a valve housing with a valve chamber, wherein the valve chamber has a chamber wall into which at least one fluid channel opens, wherein a valve core is mounted in the valve chamber, wherein the valve core is provided with a channel structure which interacts with the fluid channel, wherein a seal is allocated to the fluid channel, the seal having a sleeve-shaped retaining body, wherein the retaining body is arranged in the fluid channel, wherein a sealing body is arranged on one end face the retaining body, wherein the sealing body has a curved sealing contour which points in the direction of the valve core.

Due to the curved sealing contour, the seal is in linear contact with the valve core. If the contact is made under elastic pretension, the result is a linear contact. The linear contact results in a small contact surface, so that only a low contact pressure is required to achieve the surface pressure necessary for sealing. If the seal is formed from a material with a low coefficient of friction, which is particularly the case with thermoplastic materials, the result is a low frictional force to be overcome, which, particularly in conjunction with small valve dimensions and the associated small effective radius, leads to a low required drive torque. This increases the service life of the valve and makes it possible to use more inexpensive components.

The sealing body can be bent in a collar-shaped manner. In this embodiment, the sealing body is preferably formed thin-walled, wherein the wall thickness of the sealing body is comparable to the wall thickness of the retaining body. This allows a particularly material-saving embodiment of the seal. Due to the collar-shaped embodiment, the sealing body is resilient and can therefore seal against the valve core with elastic pretension. A resilient embodiment is also possible if a non-elastic material is selected.

A section of the sealing body can be bent in a U-shaped manner, wherein the U-shaped bent section bears sealingly against the valve core. This embodiment allows a linear contact of the sealing body with the valve core to be realized by simple means. The section can be shaped, so that the part of the section in contact with the valve core is radially on the inside. In this embodiment, the bent section is shaped in such a way that the apex is displaced radially inwards. This allows the sealing contour to be designed with minimal dead space and reduces the contact surface between the sealing body and the valve core. Particularly in connection with the collar-shaped design of the sealing body, the resilient design results in a particularly good sealing effect.

In a first embodiment, the seal is formed from elastomeric material, wherein the sealing contour of the sealing body is U-shaped.

In an advantageous embodiment, the seal is formed from a dimensionally stable and/or tough-hard plastic. Non-elastomeric materials, preferably thermoplastics, are particularly suitable. The material is selected, so that it is dimensionally stable and causes low frictional forces when the sealing body is in contact with the valve core. The shape of the sealing body can nevertheless result in resilient properties, so that the sealing body bears against the valve core with elastic pretension. Due to the low coefficient of friction, particularly in comparison with elastomeric seals, the forces to be applied by the actuator to the valve core in order to be able to move the valve core relative to the seal are particularly low. Materials such as polypropylene (PP) or polyamide (PA) can be used for the sealing body. Preferably, the seal is formed in one-piece. Due to the advantageous embodiment, it is, in particular, not necessary to provide a separate spring element, for example made of an elastomer.

The free end of the sealing body can point in the direction of the chamber wall. Particularly in connection with the collar-shaped embodiment of the sealing body made of thin-walled material, this results in a resilient contact of the free end of the sealing body with the chamber wall of the valve housing. The sealing body creates a seal in the direction of the valve housing and prevents leakage between the seal and the valve housing. With this embodiment, it is advantageous that the design of the retaining body is not important; the sealing function between the seal and the valve housing is realized via the sealing body by the free end of the sealing body pointing in the direction of the chamber wall and bearing against it with elastic pretension in a sealing manner. The free end of the sealing body is in linear contact with the chamber wall, so that a high sealing effect can be achieved with low contact pressure.

The valve core can be floatingly mounted in the fluid channel. The retaining body merely forms a supporting element that ensures the position of the seal relative to the fluid channel. Due to the floating mount, the seal can be displaced in the fluid channel. The floating mount can occur in such a way that a clearance fit is formed between the seal and the fluid channel. The displaceable embodiment ensures a permanent sealing effect and sufficient elastic contact pressure between the seal and the valve core. This embodiment is particularly advantageous during assembly of the valve because the seal only needs to be inserted into the fluid channel. The alignment of the seal, however, can take place automatically when the valve core is mounted in the valve housing. The seal can rotate automatically in the fluid channel. Accordingly, it is, in particular, not necessary to twist the seal in the correct position already during mounting.

The sealing body can be bent in an S-shaped manner between the free end and the U-shaped section. This embodiment improves the resilient effect of the sealing body and thus contributes to an overall improvement in the sealing effect.

The valve can be a rotary valve, wherein the valve core is rotatably mounted in the valve chamber. The fluid flow is adjusted by turning the valve core and can be easily controlled by an actuator. In the embodiment as a rotary valve, the valve housing can be provided with a plurality of fluid channels which interact with the valve core, wherein different fluid flows can be realized with simple means in this way. If the rotary valve is part of a temperature control circuit, it is accordingly conceivable that various components are supplied with temperature control medium via the rotary valve, wherein the temperature control medium can be used for heating or cooling.

The valve can be a switching valve that controls various components as required. Alternatively, the valve can be a proportional valve which also allows for the volume flow of the fluid to be regulated.

### BRIEF DESCRIPTION OF THE DRAWINGS

Some embodiments of the valve according to the disclosure are explained in more detail below with reference to the figures. The figures show, in each case schematically:

FIG. 1 a first embodiment of a valve in form of a rotary valve with proportional control;

FIG. 2 the valve according to FIG. 1 in sectional view;

FIG. 3 the valve according to FIG. 1 with an alternatively designed seal in sectional view;

FIG. 4 a second embodiment of a valve;

FIG. 5 a bottom view of a third embodiment of a valve;

FIG. 6 the area of a thermoplastic seal in detail in sectional view;

FIG. 7 the area of an elastomer seal in detail in sectional view;

FIG. 8 a seal in detail.

### DETAILED DESCRIPTION

The figures show a valve 1 in form of a rotary valve, which forms a part of a temperature control circuit of a device to be air-conditioned. In the present case, the valve 1 is used in electromobility applications as part of the temperature control circuit of an electric vehicle. The valve 1 is integrated into a temperature control circuit of an electric motor drive of an electric vehicle and directs volume flows of the medium conducted in the temperature control circuit to the electrical energy storage devices and electric motors as well as to the power electronics. Due to the valve 1, temperature control medium flows of the temperature control circuit can be modified.

Further, due to the valve 1, the volume flow of the temperature control medium can be increased or decreased. Furthermore, by rotating the valve core 6, different fluid channels 5 can be connected in a flow-conducting manner, thus changing the direction of flow of the temperature control medium.

Depending on the ambient temperature and power requirement, for example, a temperature control medium flow can initially be directed exclusively to the electrical energy storage devices and cool or heat the electrical energy storage devices there as required. For high power requirements, a coolant flow can be directed to the power electronics and also to the electric motors to cool these components. The modification of the coolant flow takes place by means of one or more valves 1. The actuator that causes the valve core 6 to rotate can be formed in such a way that the valve core 6 assumes discrete positions, so that the valve 1 is a switching valve. Alternatively, the actuator can be designed, so that the valve core 6 can also assume intermediate positions and form a proportional valve in this embodiment.

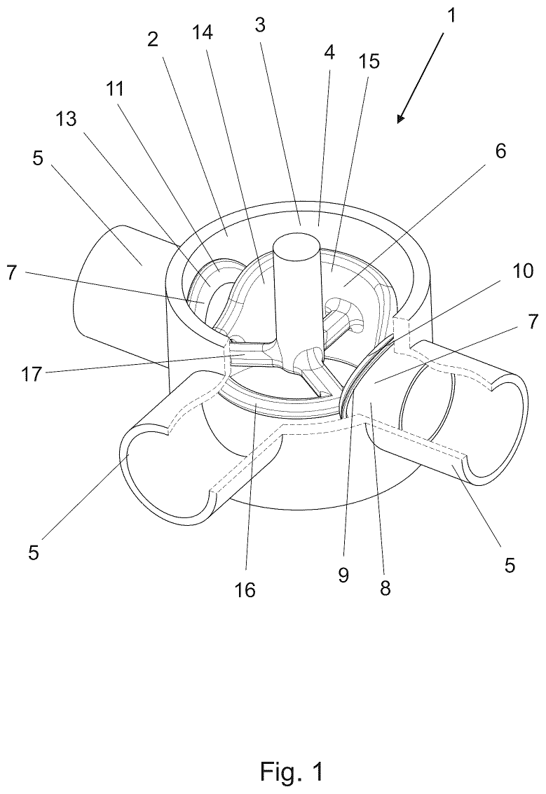

FIG. 1 shows a first embodiment of a valve 1 with a valve housing 2 formed from plastic in which a valve chamber 3 is formed. The valve chamber 3 has a chamber wall 4 into which several fluid channels 5 open. In the depicted exemplary embodiment, three fluid channels 5 are provided, one of which supplies a fluid and two of which discharge the fluid. A valve core 6 is rotatably mounted in the valve chamber 3, wherein the valve core 6 is provided with a channel structure which interacts with the fluid channels 5. As the valve core 6 is rotatably mounted in the valve chamber 3, the valve 1 forms a rotary valve. To facilitate recognizing the individual components, the valve 1 is partially depicted in a break-out view.

The valve core 6 has a valve core jacket 14. The valve core jacket 14 is formed circumferentially. It has a first section 15 which, depending on the position of the valve core 6, bears sealingly against the seal 7 in order to close a fluid channel 5. The valve core jacket 14 has a second section 16 which is formed in such a way that, depending on the position of the valve core 6, the fluid channel 5 is completely or partially free in order to connect the fluid channel 5 to the valve chamber 3 in a flow-conducting manner. In particular, the first section 15 can be a ring section that can cover the entire cross-sectional area of the fluid channel 5. For this purpose, the first section 15 can be formed as a cylinder section. The second section 16 can be formed as a ring section that does not cover the entire cross-sectional area of the fluid channel 5.

In FIG. 1, the valve core jacket 14 is connected to a valve core axis via three connecting webs 17.

In FIG. 1, a seal 7 is allocated to each of the two fluid channels 5 which are formed as fluid channels that are discharging flow from the valve chamber 3. The seal 7 has a sleeve-shaped retaining body 8, wherein the retaining body 8 is arranged in the fluid channel 5. A sealing body 10 is arranged on one end face 9 of the retaining body 8, wherein the sealing body 10 has a curved sealing contour 11 which points in the direction of the valve core 6.

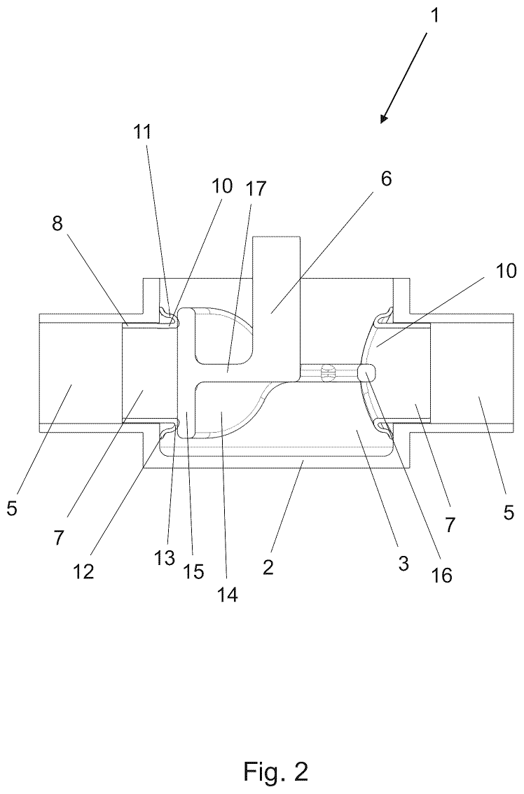

The sealing body 10 is bent in a collar-shaped manner. The wall thickness of the sealing body 10 essentially corresponds to the wall thickness of the retaining body 8. A section 13 of the sealing body 10 is bent in a U-shaped manner, wherein the U-shaped bent section 13 bears sealingly against the valve core 6. The free end 12 of the sealing body 10 (see also FIG. 2) points in the direction of the chamber wall 4 and bears sealingly against it.

The retaining body 8 is floatingly mounted in the fluid channel 5. There is a clearance fit between the retaining body 8 and fluid channel 5, so that the retaining body 8 can rotate automatically relative to the fluid channel 5.

The valve 1, which is formed as a rotary valve, has only a small number of parts and essentially consists only of a valve housing 2, a valve core 6, a seal 7 for each fluid channel 5 and possibly an additional seal, which seals the valve core 6 on the end face at the passage of a switching shaft in the direction of the actuator.

The valve 1 shown in FIG. 1 is designed as a proportional valve. The valve core 6 is configured to be able to completely block only one fluid channel 5. Intermediate positions are also possible, so that at least a partial volume flow can be directed through all fluid channels 5.

FIG. 2 shows a sectional view of valve 1 as shown in FIG. 1. It can be seen that a section 13 of the sealing body 10 is bent in a U-shaped manner, wherein the U-shaped bent section 13 bears sealingly against the valve core 6. The free end 12 of the sealing body 10 points in the direction of the chamber wall 4 and bears sealingly against it. The sealing body 10 is bent in an S-shaped manner between the free end 12 and the U-shaped section 13. The seal 7 is formed from dimensionally stable, thermoplastic material, for example polypropylene or polyamide.

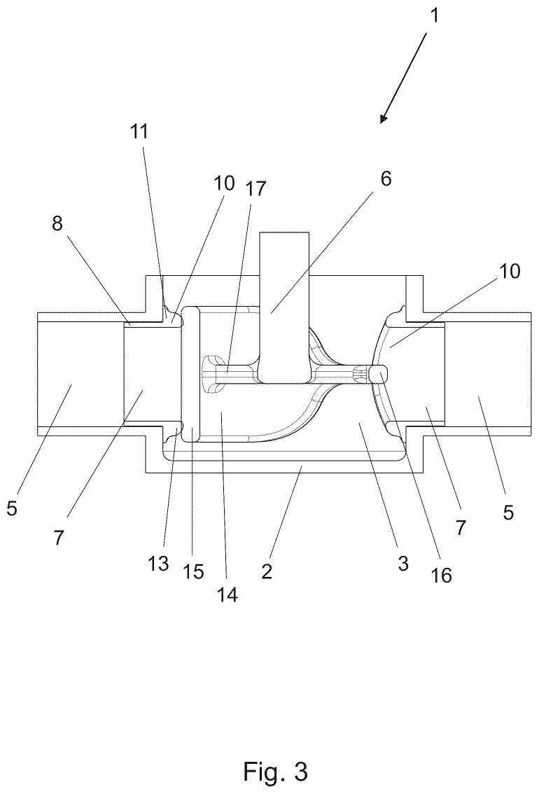

FIG. 3 shows the valve 1 according to FIG. 1, wherein the seal 7 is formed from elastomeric material in this embodiment. In this embodiment, a section 13 of the sealing body 10 is also bent in a U-shaped manner and the U-shaped bent section 13 bears sealingly against the valve core 6. However, the sealing body 10 is not thin-walled, but consists of solid material.

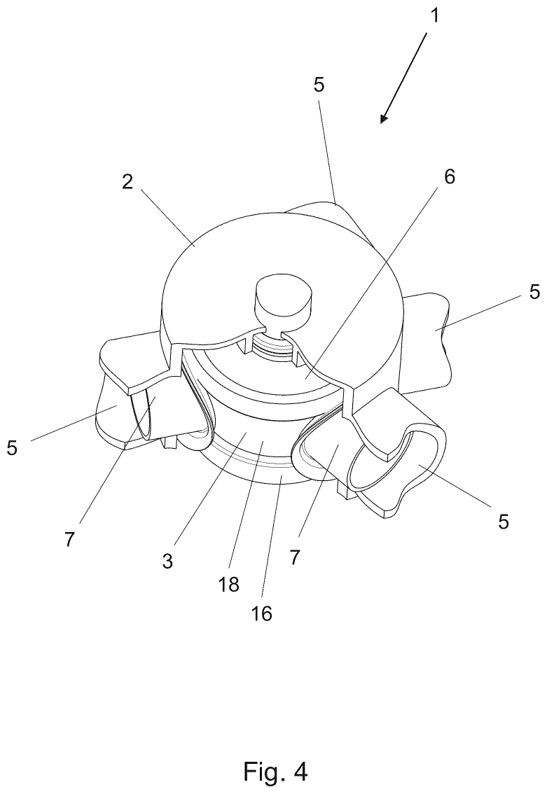

FIG. 4 shows an alternative embodiment of the valve 1 shown in FIG. 1. In this embodiment, the valve comprises four fluid channels 5. The valve 1 shown in FIG. 4 is also designed as a proportional valve. However, the valve core 6 is configured to connect two adjacent fluid channels 5 in a flow-conducting manner. Intermediate positions are also possible, so that the volume flow in the direction of a fluid channel 5 can be modified. For this purpose, the valve core 6 has a cylindrical design. A recess is made in the cylindrical wall, the recess extending over a part of the circumference of the wall.

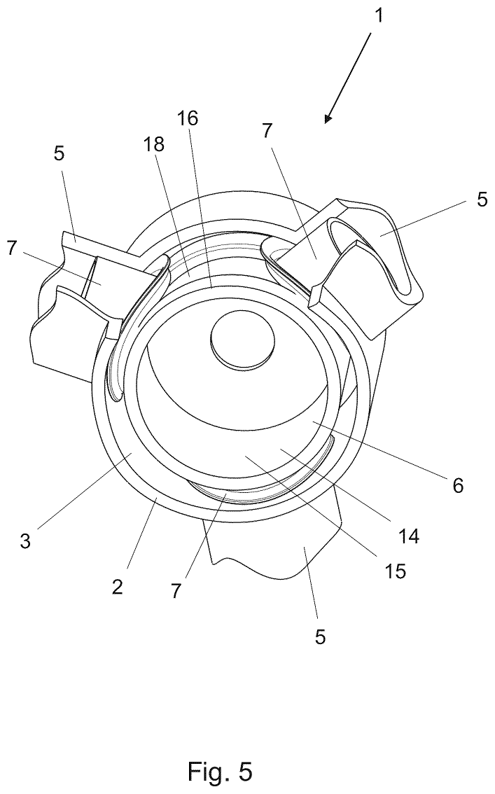

FIG. 5 shows a further embodiment of valve 1 in a bottom view. In this embodiment, the valve 1 comprises three fluid channels 5. A seal 7 is allocated to all fluid channels 5. In this embodiment, a fluid can flow in through an opening on the underside of the valve housing 2, which is not shown.

In FIGS. 4 and 5, the valve core jacket 14 has a recess 18 in the second section 16 in order to connect the fluid channel 5 to the valve chamber 3 in a flow-conducting manner, depending on the position of the valve core 6.

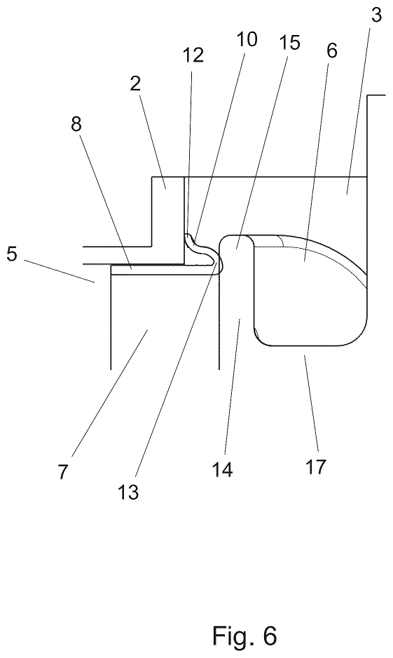

FIG. 6 shows the valve 1 according to FIG. 4 in detail in the area of the seal 7 in sectional view. It can be seen that a section 13 of the sealing body 10 is bent in a U-shaped manner, wherein the U-shaped bent section 13 bears sealingly against the valve core 6. The free end 12 of the sealing body 10 points in the direction of the chamber wall 4 and bears sealingly against it. The sealing body 10 is bent in an S-shaped manner between the free end 12 and the U-shaped section 13. The seal 7 is formed from thermoplastic material, for example polypropylene or polyamide.

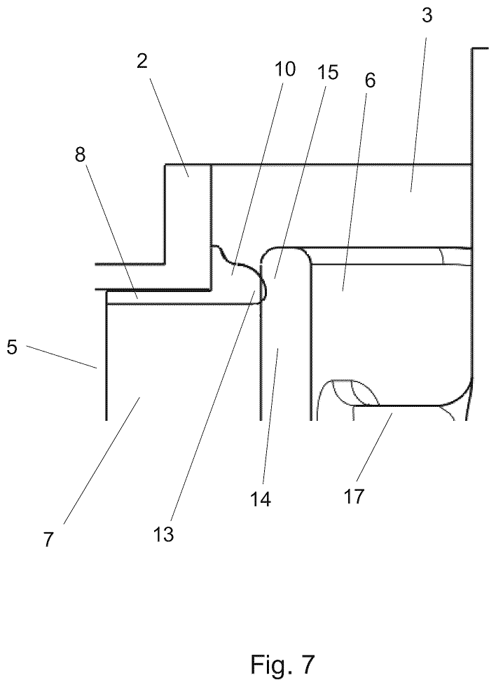

FIG. 7 shows the valve 1 according to FIG. 4 in detail in the area of the seal 7 in sectional view, wherein the seal 7 is formed from elastomeric material in this embodiment. In this embodiment, a section 13 of the sealing body 10 is also bent in a U-shaped manner and the U-shaped bent section 13 bears sealingly against the valve core 6. However, the sealing body 10 is not thin-walled, but consists of solid material.

Alternatively, it is conceivable to design valve 1 as a switching valve. In this embodiment, the valve core 6 is configured to optionally connect fluid channels 5 to each other in a flow-conducting manner. The valve housing 2 can optionally be provided with a different number and arrangement of fluid channels 5. The arrangement and embodiment of the valve core 6 is also variable. The variable embodiment of valve housing 2 and valve core 6 allows, for example, for the design of a proportional valve with one or more recesses, the embodiment of a switching valve with valve core 6 with channel structures or the embodiment of a combined proportional/switching valve.

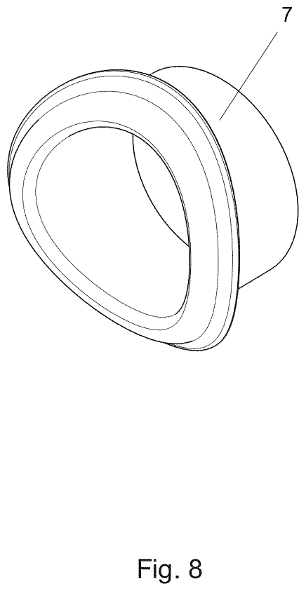

FIG. 8 shows in detail a seal 7 for one of the valves 1 shown above. The seal 7 is floatingly mounted in each fluid channel 5 that is to be sealed against the valve core 6. Due to the floating mount, the seal 7 can displace in the fluid channel 5 and also twist during assembly.

In FIGS. 2, 3, 6 and 7, the sealing body 10 is depicted in its undeformed state. This is indicated graphically by an overlap with the valve core 6. In a real product, this results in a pre-tensioning of the seal 7 between the valve core 6 and the valve housing 2, which improves the sealing effect.

1. A valve, comprising a valve housing with a valve chamber, wherein the valve chamber has a chamber wall into which at least one fluid channel opens, wherein a valve core is mounted in the valve chamber, wherein the valve core is provided with a channel structure which interacts with the fluid channel, wherein a seal is allocated to the fluid channel, the seal having a sleeve-shaped retaining body, wherein the retaining body is arranged in the fluid channel, wherein a sealing body is arranged on one end face of the retaining body, and wherein the sealing body has a curved sealing contour which points in the direction of the valve core.

2. The valve according to claim 1, wherein the sealing body is bent in a collar-shaped manner.

3. The valve according to claim 1, wherein a section of the sealing body is bent in a U-shaped manner, wherein the section bears sealingly against the valve core.

4. The valve according to claim 1, wherein the seal is formed from a dimensionally stable plastic.

5. The valve according to claim 1, wherein the seal is formed from a tough-hard plastic.

6. The valve according to claim 1, wherein the seal is formed in one piece.

7. The valve according to claim 1, wherein the seal is formed from thermoplastic material.

8. The valve according to claim 1, wherein the free end of the sealing body points in the direction of the chamber wall.

9. The valve according to claim 8, wherein the free end of the sealing body bears against the chamber wall.

10. The valve according to claim 1, wherein the valve core is floatingly mounted in the fluid channel.

11. The valve according to claim 3, wherein the sealing body is bent in an S-shaped manner between the free end and the U-shaped section.

12. The valve according to claim 1, formed as a rotary valve, wherein the valve core is rotatably mounted in the valve chamber.

13. The valve according to claim 1, formed as a switching valve or as a proportional valve.
